(19) United States
(12) Patent Application Publication
(10) Pub. No.: US 2015/0109111 A1
(43) Pub. Date: Apr. 23, 2015

(54) Wireless Door Chime

(71) Applicant: The Chamberlain Group, Inc., Elmhurst, IL (US)

(72) Inventors: Jonathan Arnold Lee, LaGrange, IL (US); Mark Alan Zavada, Chicago, IL (US)

(21) Appl. No.: 14/496,622

(22) Filed: Sep. 25, 2014

Related U.S. Application Data
(60) Provisional application No. 61/894,690, filed on Oct. 23, 2013.

(51) Int. Cl. G08B 3/10

(52) U.S. Cl. CPC G08B 3/1016
USPC 340/328

(57) ABSTRACT

A wireless door chime apparatus operates in connection with a trigger device installed at a doorway. The wireless door chime apparatus has a decorative housing, such as a vase, bowl, candle, statue, or lamp, for example. A wireless speaker unit configured to generate audible sounds is mounted to the decorative housing. The wireless door chime apparatus also has a power connection mechanism that can supply electric power to the wireless door chime apparatus. The wireless door chime apparatus produces an audible notification in response to receiving a wireless signal generated by the trigger device.

### RELATED APPLICATIONS

This application claims the benefit of U.S. Provisional application No. 61/894,690, titled “Wireless Vase Door Chime,” and filed on Oct. 24, 2013, which is hereby incorporated by reference in its entirety.

### TECHNICAL FIELD

The present disclosure relates generally to decorative objects. More specifically, the present disclosure relates to decorative objects configured to operate as a wirelessly activated speaker or audio signaling device.

### BACKGROUND

Electric doorbells often reside on an internal wall of a home or residence. Such doorbell units are typically electrically hard-wired to the power mains of the home and to a doorbell activating pushbutton located by a doorway or entryway.

With the development of wireless technology, it is no longer necessary for doorbell units to be hard-wired to the homes. Wireless technology allows pushbutton transmitters to be installed in a doorway to generate wireless signals that activate a doorbell unit. Further, batteries or other portable power sources can supply electric power without a constant connection to the house power mains. Accordingly, portable doorbell units can be positioned around a home and yard to ensure that a user can hear a doorbell signal when activated.

### SUMMARY

The present disclosure provides a wireless door chime apparatus configured to operate in connection with a trigger device installed at a doorway. The wireless door chime apparatus can include a decorative housing and a wireless speaker unit mounted to the decorative housing. The wireless speaker unit can be configured to produce audible sounds, such as chimes, tones, bells, whistles, or music, for example. The wireless door chime apparatus can also have a power connection mechanism. The power connection mechanism can be an electrical power source, or can be configured to connect with an electric power source to thus supply electric power to the wireless door chime apparatus. The wireless door chime apparatus can be configured to produce an audible notification in response to receiving a wireless signal generated by the trigger device. For example, when a user presses a pushbutton doorbell to activate the trigger device, the wireless door chime apparatus and/or the wireless speaker unit can generate an audible notification signal, such as a chime, tone, or bell.

The present disclosure also provides other embodiments of a wireless door chime apparatus configured to operate in connection with a trigger device installed at a doorway. For example, in some embodiments the wireless door chime apparatus comprises a vase configured to receive plants. The vase can have at least one aperture. In certain aspects, a wireless speaker unit is installed in an internal portion of the vase. The wireless speaker unit can be configured to produce audible sounds. In this manner, the aperture(s) on the vase may facilitate distribution of sound generated by the wireless speaker unit outside the vase. A power connection mechanism can be configured to connect with an electric power source and to supply electric power to the wireless speaker unit. In operation, the wireless speaker unit can produce an audible notification in response to receiving a wireless signal generated by the trigger device.

The present disclosure also provides a method for generating a door chime signal with a vase. The method includes the steps of receiving a decorative object, such as a plant or flower, within an internal portion of the vase. The method also includes receiving, via a wireless speaker unit installed in the internal portion of the vase, a wireless signal generated by a trigger device installed at a doorway. The method can also include the step of producing, with the wireless speaker unit, an audible notification in response to the wireless speaker unit receiving the wireless signal generated by the trigger device.

### BRIEF DESCRIPTION OF THE DRAWINGS

FIG. 1A shows a room in a home using a wireless door chime in accordance with at least one embodiment of the present disclosure.

FIG. 1B shows a doorway of a home using a wireless door chime in accordance with at least one aspect of the present disclosure.

FIG. 2 shows a wireless door chime in accordance with at least one embodiment of the present disclosure.

FIG. 3 shows a wireless door chime with a power connection cord in accordance with at least one embodiment of the present disclosure.

FIG. 4 shows the internal structure of a wireless door chime in accordance with at least one embodiment of the present disclosure.

FIG. 5 is a bottom view of a wireless door chime in accordance with at least one embodiment of the present disclosure.

FIG. 6 is a flow chart of an example method in accordance with at least one embodiment of the present disclosure.

### DETAILED DESCRIPTION

A portable doorbell unit can stand out as a purely functional item that adds no decorative value to the home. When placed in the home, a portable doorbell unit can appear intrusive and visually distracting and can diminish the aesthetic appearance and feel of the home decor. The present disclosure provides a wireless door chime apparatus that uses an attractive decorative housing that can accommodate the look and feel of a home's decor.

The present disclosure also provides a wireless door chime that utilizes wireless technology, for example Bluetooth, to function as a speaker for a music or audio player. Like portable doorbells, wireless speakers can be large and obtrusive, and generally diminish the look of a home's decor. By incorporating a wireless door chime into a wireless speaker, and further incorporating the wireless speaker into a decorative housing, the presently disclosed wireless door chime combines multiple non-aesthetic objects into a single, visually attractive decorative object.

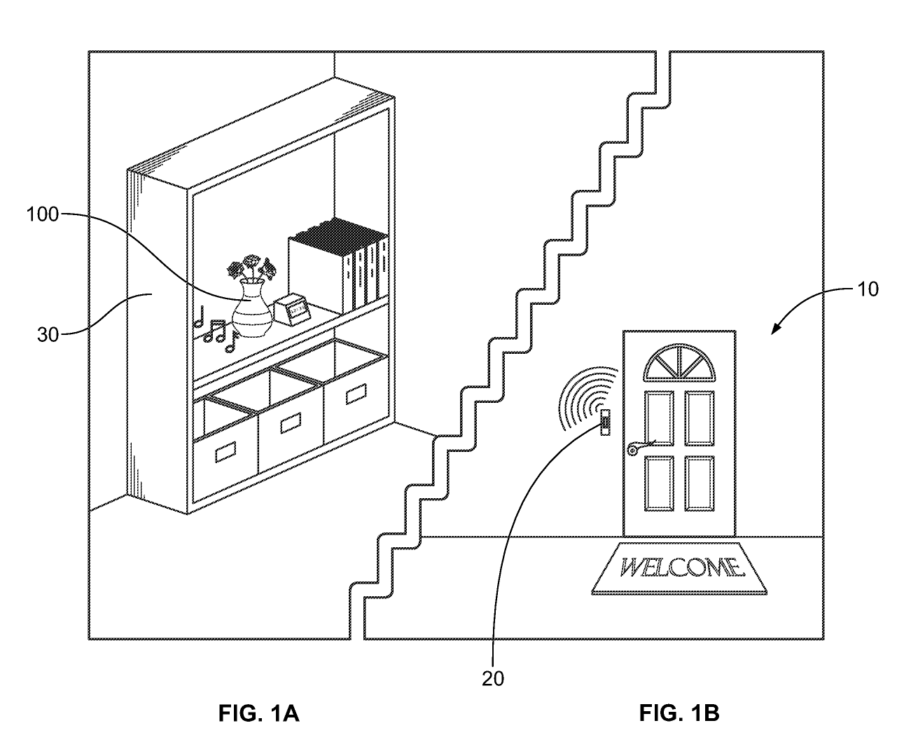

Embodiments of a wireless door chime apparatus are depicted in the accompanying figures. FIG. 1A provides a scene of an indoor environment to a home with a wireless door chime 100 positioned on a bookshelf 30. In FIG. 1A, the wireless door chime 100 takes on the appearance of a vase with plants or flowers located therein. The wireless door chime 100 is capable of generating audible sounds, such as bells, tones, and/or music.

FIG. 1B provides a scene of a doorway 10 to the home, with a doorbell trigger device 20 positioned on the left side of the door. The trigger device 20 can be a common doorbell button or other similar pushbutton device, but the trigger device 20 can also take on other configurations. For example, the trigger device 20 can be a touchscreen interface that allows a user to activate the trigger 20 by touching a location on an interface of the device. In some embodiments, the trigger device 20 can be an optical sensor configured to automatically activate the trigger device 20 when the sensor detects the presence of a person at the doorway 10.

Upon activation, the trigger device 20 can transmit a wireless signal throughout the home. For example, when a user presses the pushbutton doorbell on the trigger device 20, the trigger device 20 can broadcast a wireless signal throughout the home. The wireless door chime 100 can be configured to receive signals from or otherwise communicate wirelessly with the trigger device 20. Accordingly, the wireless door chime 100 can be configured to generate an audible notification or door chime in response to signals generated and/or transmitted by the trigger device 20.

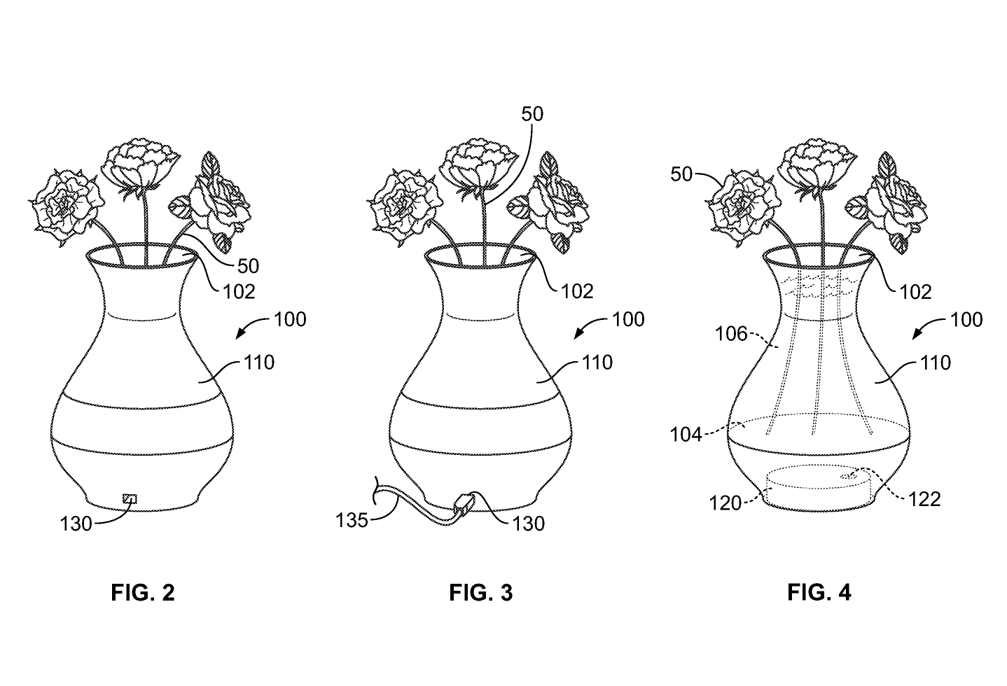

FIGS. 2-4 are more detailed views of some embodiments of a wireless door chime 100. As shown in FIG. 2, the wireless door chime 100 includes a decorative housing 110, which can be a vase, as shown in the figures. The wireless door chime can also include a power connection mechanism 130, which can be, for example, a port, as shown in FIG. 2. Further, as shown in FIG. 4, which is a semi-transparent view of the wireless door chime 100 to show the internal structure, a wireless speaker unit 120 is mounted to the decorative housing 110.

The power connection mechanism 130 allows the wireless door chime 100 to be connected to a power source. For example, a detachable connector cord 135 as shown in FIG. 3 can connect the power connection mechanism 130 with an external power source. In this way the power connection mechanism 130 can be configured to connect to a mains power supply, a wall power supply, or a solar supply.

In some aspects, the power connection mechanism 130 can be a USB port that allows the wireless door chime 100 to connect to a computer or other electronic device. The wireless door chime can thus receive electrical power from the computer or electronic device while communicating directly with the computer. For example, the wireless door chime apparatus 100 can connect with a computer or other device to download audio files that can be played back via the wireless speaker 130 at a later time.

In some embodiments, the wireless door chime 100 can include its own internal power source. For example, the wireless door chime 100 can include an internal battery unit that provides electrical power to the wireless door chime 100 and/or the wireless speaker 130. The battery unit can be a rechargeable battery that can be recharged, for example, via the power connection mechanism 130. In some embodiments, the battery unit can be a battery cartridge that allows for the installation of standard, off-the-shelf replaceable batteries, such as AAA, AA, or 9-volt batteries. In some embodiments, the power connection mechanism 130 can be, can include, or can be configured to connect with one or more of the following: a rechargeable battery, a USB port, a mains power supply, a wall wart power supply, a computer, and a solar power supply.

Wireless speaker unit 120 is configured to produce audible sounds upon the receipt of wireless signals. The wireless speaker unit 120 can include an antenna or a wireless communication device 122, as shown in FIG. 4. The wireless speaker unit 120 can be a Bluetooth speaker, for example, that can detect wireless signals and play an audio stream based on those signals. For example, the wireless speaker unit 120 can be configured to play an audible notification, such as a bell, a chime, or another notification signal in response to receiving a wireless signal generated by the trigger device 20, thereby indicating that a person is present at the doorway 10.

The wireless speaker unit 120 can also be configured to communicate wirelessly with an audio source, such as an mp3 player, a smart phone, a tablet, a radio, a computer, or another source capable of storing audio files. In this way, the wireless speaker unit 120 can play audio files transmitted from the audio source, thereby serving as a home speaker or a home audio system. For example, the wireless speaker unit 120 can be configured to connect with a user's smart phone to play an audio stream controlled by a user via the smart phone. In this way, the wireless speaker unit 120 can play mp3 or other audio files or stream audio from the internet.

The wireless door chime 100 can be configured to override the audio stream upon the detection of a wireless signal from the trigger device 20. For example, in response to receiving a wireless signal from the trigger device 20, the wireless speaker unit 120 can be configured to temporarily suspend any audio stream and generate an audible notification.

The audible notification can be a common “doorbell” signal, such as a bell, tone, or chime. In some embodiments, the notification can be a customized tone, sound, or song. For example, the tone can be a pre-recorded sound of a user's voice or a snippet of an audio file.

After generating the audible notification signal, the wireless speaker unit 120 may resume playing the audio stream automatically. Alternatively, the wireless speaker unit 120 can be configured to wait for user prompting before resuming the audio stream.

In some embodiments, the wireless door chime 100 can be configured to produce a notification signal separate from the wireless speaker unit 120. For example, in some embodiments, the wireless door chime 100 can include a second speaker that is dedicated solely to playing a doorbell notification signal.

As shown in FIGS. 2-4, the housing 110 is decorative in nature, and can be, for example, a vase. In some embodiments, the housing 110 can be configured to receive plants or flowers 50 within an internal portion 102 of the housing 110. In some aspects, the plants or flowers 50 can be plastic or artificial. As shown in FIG. 4, the housing 110 can be configured to receive water 106 or other fluids to support the flowers 50 located within. In such an embodiment, the housing 110 may include a water-tight separator 104 to keep the wireless speaker unit 120 dry.

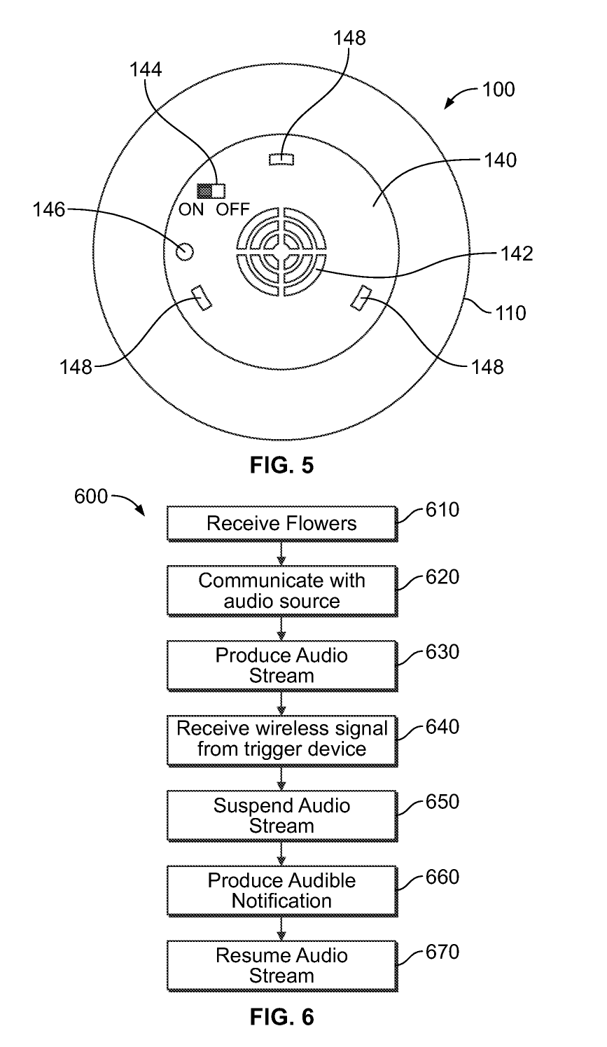

FIG. 5 is a bottom view of the housing 110 for a wireless door chime 100. As shown, the bottom surface 140 of the housing 110 can include one or more apertures 142 that facilitate the distribution of sound generated by the wireless speaker unit 120 outside the vase. The apertures 142 can be arranged in a circumferential pattern as shown in FIG. 5, or in another configuration to effectively distribute sound based on the shape and size of the wireless door chime 100. For example, the apertures 142 can be arranged in a grid-like pattern on the bottom surface 140 of the housing 110.

Some aspects of the wireless door chime 100 can include protrusions 148 located on the bottom surface 140 of the housing 110. These protrusions 148 lift the housing 110 and provide a separation between the bottom surface 140 and the placement surface to further facilitate the distribution of sound. The bottom surface 140 can also include an on/off switch 144 and an LED indicator 146, which can indicate the power level of the door chime 100 or the quality of wireless signal detected, for example.

FIG. 5 shows the apertures 142 located on the bottom surface 140 of the housing 110 so that the apertures are not generally viewable when the door chime 100 is on typical display. However, in certain embodiments, apertures 142 can be located on various other locations of the housing 110 to improve the sound distribution of the door chime 100. For example, the apertures 142 can be arranged to extend around the circumference of the housing 110 and to project sound in multiple directions. In certain embodiments the apertures 142 may be incorporated into the decorative nature of the housing 110. For example, the apertures 142 can be holes in a lattice configuration that also provide decorative value.

The decorative housing 110 has been described and depicted in FIGS. 2-4 as a vase, but it should be understood that the housing 110 can also take on a variety of other decorative and/or functional forms. For example, the housing 110 can be a bowl, a plate, a candle holder, a candle, a statue or sculpture, a picture frame (e.g., a standard or digital picture frame), a lamp, a tissue box cover, a pen or pencil holder, a paper holder, an organizer, a book or bookend, a clock, a trophy, or a mirror, for example. In some embodiments, the decorative housing 110 can be an artificial or electronic candle. The electronic candle can include a light source, for example, an LED light that simulates the appearance of a candle flame. The light source can be connected to the power connection mechanism 130 so that the same power source powering the wireless speaker unit 120 also supplies power to the light source.

FIG. 6 is a flow chart of an example method 600 for generating a door chime signal in accordance with at least one embodiment of the present disclosure. The method 600 uses wireless door chime as described herein, and thus can use a wireless door chime that takes on various shapes, designs, and functionality. Accordingly, various steps of the method 600 may vary depending on the shape, design, and functionality of the wireless door chime.

One example embodiment of method 600 involves generating a door chime signal with a wireless door chime configured to operate as a vase. At step 610, the method 600 can include receiving a decorative object within the vase. For example, step 610 can include placing a plant or flower in an interior compartment of the wireless door chime and providing water, dirt, seeds, or other substances that promote the life of the plant or flower. In some embodiments, step 610 can include placing artificial plants or flowers in the vase or inserting other decorative objects such as balloons, flags, signs, beads, ornaments, decorative rocks or stones, electric lights, or candles in the vase.

In some embodiments, the wireless door chime can have a wireless speaker unit, such as the wireless speaker unit described herein. Accordingly, at step 620, the method can include communicating, via the wireless speaker unit, with an audio source. For example, at step 620, the method 600 can include communicating with an mp3 player, a smart phone, a tablet, a radio, a computer, or another source capable of storing audio files.

At step 630, the wireless speaker unit produces an audio stream. For example, the wireless speaker unit can be configured to connect with a user's smart phone to play an audio stream as controlled by the user via the smart phone. In this way, the wireless speaker unit can play mp3 or other audio files or stream music or audio from the internet.

At step 640, the wireless door chime receives a signal generated by a trigger device installed at a doorway. In some embodiments of the method 600, the wireless door chime can receive the wireless signal generated by the trigger device via the wireless speaker unit. The trigger device can be, for example, a common pushbutton doorbell or other device that a visitor can use to indicate their presence at the doorway, for example. The trigger device can be configured to communicate wirelessly with the wireless door chime apparatus, for example, by generating a wireless signal in response to a user pressing a doorbell button.

The method can also include, at step 650, suspending the audio stream generated by the wireless speaker unit in response to detecting the wireless signal generated by the trigger device. For example, if the wireless speaker unit is playing an audio stream such as a song transmitted by a remote mp3 player, the wireless speaker may suspend the audio stream in order to generate a door chime notification.

At step 660, the wireless door chime produces an audible notification in response to the trigger device. The audible notification can be a common “doorbell” signal, such as a bell or a chime. In some embodiments, the notification can be a customized tone, sound, or song. For example, the tone can be a pre-recorded sound of a user's voice, or a snippet of an audio file. The audible notification can be generated, for example, by the wireless speaker unit, or by some other sound producing device installed in the wireless door chime.

At step 670, the wireless speaker unit resumes playing an audio stream. In some embodiments, the method 600 temporarily suspends the audio stream at step 650 to produce the notification signal, and then automatically resumes playing the audio stream at step 670. In other embodiments, however, the audio signal can be suspended indefinitely at step 650, and only resumed at step 670 when a user takes active steps to resume the audio stream, for example, by pressing a “resume” or “un-pause” button on the audio source.

The present disclosure provides a decorative home object that can be used as both a portable door chime and a wireless speaker unit. The described wireless door chime thus combines multiple unattractive functional objects into an single, visually appealing decorative object.

The present disclosure describes preferred embodiments and examples of the present technology. Reference throughout this specification to “one embodiment,” “an embodiment,” or similar language means that a particular feature, structure, or characteristic described in connection with the embodiment is included in at least one embodiment of the present invention. The embodiments shown in the drawings, if any, and as described above are merely for illustrative purposes and not intended to limit the scope of the invention. Moreover, those skilled in the art will recognize that a wide variety of modifications, alterations, and combinations can be made with respect to the above described embodiments without departing from the scope of the invention as set forth in the claims, and that such modifications, alterations, and combinations are to be viewed as being within the ambit of the inventive concept. Thus, appearances of the phrases “in one embodiment,” “in an embodiment,” and similar language throughout this specification may, but do not necessarily, refer to the same embodiment. All references cited in the present disclosure are hereby incorporated by reference in their entirety.

What is claimed is:

1) A wireless door chime apparatus configured to operate in connection with a trigger device installed at a doorway, the wireless door chime apparatus comprising:
a decorative housing;
a wireless speaker unit mounted to the decorative housing, the wireless speaker unit configured to produce audible sounds; and
a power connection mechanism configured to connect with an electric power source and to supply electric power to the wireless door chime apparatus;
wherein the wireless door chime apparatus is configured to produce an audible notification in response to receiving a wireless signal generated by the trigger device.

2) The wireless door chime apparatus of claim 1, wherein the wireless speaker unit is configured to produce the audible notification in response to receiving a wireless signal generated by the trigger device.

3) The wireless door chime apparatus of claim 1, wherein the wireless speaker unit is configured to communicate wirelessly with an audio source and play an audio stream based on information communicated by the audio source.

4) The wireless door chime apparatus of claim 3, wherein the wireless speaker unit is configured to temporarily suspend the audio stream and generate an audible notification in response to receiving a wireless signal generated by the trigger device.

5) The wireless door chime apparatus of claim 1, wherein the power connection mechanism is configured to be, or to connect with at least one of a battery, a rechargeable battery, a USB port, a mains power supply, a wall wart power supply, a computer, and a solar power supply.

6) The wireless door chime apparatus of claim 1, wherein the decorative housing is a vase.

7) The wireless door chime apparatus of claim 6, wherein the vase is configured to receive plants.

8) The wireless door chime apparatus of claim 6, wherein the vase comprises at least one artificial plant.

9) The wireless door chime apparatus of claim 6, wherein the wireless speaker unit is installed in an internal portion of the vase, and wherein the vase comprises at least one aperture configured to facilitate distribution of sound generated by the wireless speaker unit outside the vase.

10) The wireless door chime apparatus of claim 1, wherein the decorative housing is an artificial candle.

11) The wireless door chime apparatus of claim 10, wherein the artificial candle comprises a light source.

12) The wireless door chime apparatus of claim 11, wherein the power connection mechanism provides electric power to the light source.

13) The wireless door chime apparatus of claim 11, wherein the light source is configured to simulate the appearance of a candle flame.

14) The wireless door chime apparatus of claim 1, wherein the decorative housing is at least one of a bowl, a plate, a candle holder, a statue, a sculpture, a picture frame, a lamp, a tissue box cover, a pen holder, a paper holder, an organizer, a book, a book end, a clock, a trophy, and a mirror.

15) A wireless door chime apparatus configured to operate in connection with a trigger device installed at a doorway, the wireless door chime apparatus comprising:
a vase configured to receive plants, the vase having at least one aperture;
a wireless speaker unit installed in an internal portion of the vase, the wireless speaker unit configured to produce audible sounds; and
a power connection mechanism configured to connect with an electric power source and to supply electric power to the wireless speaker unit;
wherein the aperture is configured to facilitate distribution of sound generated by the wireless speaker unit outside the vase, and
wherein the wireless speaker unit is configured to produce an audible notification in response to receiving a wireless signal generated by the trigger device.

16) The wireless door chime apparatus of claim 15, wherein the wireless speaker unit is configured to communicate wirelessly with an audio source and play an audio stream based on information communicated by the audio source.

17) The wireless door chime apparatus of claim 16, wherein the wireless speaker unit is configured to temporarily suspend the audio stream and generate an audible notification in response to receiving a wireless signal generated by the trigger device.

18) A method for generating a door chime signal with a vase, the method comprising the steps of:
receiving a decorative object within an internal portion of the vase;
receiving, via a wireless speaker unit installed in the internal portion of the vase, a wireless signal generated by a trigger device installed at a doorway;
producing, with the wireless speaker unit, an audible notification in response to the wireless speaker unit receiving the wireless signal generated by the trigger device.

19) The method of claim 18, further comprising the steps of:
wirelessly communicating, via the wireless speaker unit, with an audio source; and
producing, with the wireless speaker unit, an audio stream based on information communicated by the audio source.

20) The method of claim 19, further comprising the step of temporarily suspending the audio stream to produce an audible notification in response to receiving a wireless signal generated by the trigger device.
